(19) United States
(12) Patent Application Publication
(10) Pub. No.: US 2026/0225192 A1
(43) Pub. Date: Aug. 6, 2026

(54) ARC WELDING SYSTEM, AND ARC WELDING METHOD USING SUCH A SYSTEM

(71) Applicant: EUROPE TECHNOLOGIES, CARQUEFOU (FR)

(72) Inventors: Louis GUIBERT, SAINTE MAURE DE RE (FR); Etienne CHOVE, NANTES (FR)

(21) Appl. No.: 19/149,370

(22) PCT Filed: Jan. 17, 2024
(86) PCT No.: PCT/EP2024/050988

§ 371 Date: Jul. 18, 2025

(30) Foreign Application Priority Data
Jan. 19, 2023 (FR) FR2300505

(51) Int. Cl. B23K 37/02

(52) U.S. Cl. CPC B23K 37/0294; B23K 37/0241

(57) ABSTRACT

An arc welding system (1) for welding two parts (P) together has at least one base (2) movable relative to the surface of one of the parts (P) to be welded in a direction of travel (D). A torch support (6) is arranged to receive an arc welding torch (T) being of the type employing a wire electrode (F). A first actuator (10) and a second actuator (11) are provided for moving the support (6) relative to the base (2) in a plane (Pt) substantially transverse to the direction of travel (D) of the base (2) relative to the parts (P) and in two different directions, each non-parallel to the longitudinal axis (L) of the torch. A control unit (20) is configured to control the first and second actuators (10, 11) in a coordinated manner as a function of the trajectory to be imparted to an end (30) of the wire electrode (F).

### TECHNICAL FIELD

The present invention relates to the welding of parts, in particular for the automotive, aeronautics, civil engineering, marine, metal construction and railway industries.

The invention relates in particular to movable arc welding systems suitable for various welding configurations.

### PRIOR ART

In order to reduce the amount of material deposited while two parts are being welded to one another, it is known practice to reduce the opening angle of the bevel, in particular to angle values less than or equal to 40°.

In such a configuration, to obtain good penetration and limit the risks of weld defects, it is necessary to incline the wire electrode of the torch such that the wire electrode is brought as close as possible to the normal to the surface of the bevel.

On current movable welding carriages with a pendulum axis, the oscillation amplitude is limited owing to the distance between the point of contact and the point of rotation, which limits the inclination obtained to 5°. This does not allow the wire electrode to be oriented properly on the metal sheet. As a result, these welds are generally produced manually by an experienced operator.

Similarly, to weld metal sheets at right angles, the actuators for displacing the welding torch must currently be manually mechanically oriented before the weld is produced. In addition, during the welding operation, a torch with an orientation that remains identical is used to perform the sweep. As a result, the orientation of the wire electrode at the ends of the weld bead is relatively far away from the local normal, and this does not allow good penetration of the weld.

For the situations set out above, it is known practice to use welding torches of a particular geometry. However, such torches are suitable for only one type of weld. It is therefore necessary to change the torch depending on the geometry of the weld to be produced, and this makes the production of the weld more complex and increases the purchase and use costs.

There is a need for a movable welding system which makes it possible, during welding operations, to retain a good orientation of the wire electrode while at the same time making it easier to use the system.

### SUMMARY OF THE INVENTION

The present invention meets this need by virtue of an arc welding system for welding two parts to one another, comprising at least:
a base which is movable relative to the surface of one of the parts to be welded in an advancement direction,
a holder for a torch, the holder being arranged to receive an arc welding torch with a wire electrode,
a first actuator and a second actuator for displacing the holder relative to the base in a plane substantially transverse to the advancement direction of the base relative to the parts and in two different directions neither of which is parallel to the longitudinal axis of the torch, and
a control unit configured to control the first and second actuators in coordinated fashion on the basis of the trajectory to be imparted to an end of the wire electrode.

The invention makes it possible to produce welds on different geometries without having to manually modify in advance the position on the basis of the first and/or second actuator(s). This makes it easier to install the system and limits the risks of poor positioning of the torch during the welding operation.

Moreover, the coordinated control of the first and second actuators allows precise positioning of the welding torch, thus making it possible to optimize the trajectory of the wire electrode and the weld.

The system also makes it possible to use a standard welding torch, thereby limiting the cost of purchasing the equipment. In addition, this limits the need for training on different types of equipment, since manual welding and welding on the system are performed with the same torch, or even with the same welding station.

“Displacing the holder relative to the base in a plane substantially transverse to the advancement direction of the base relative to the parts” is understood to mean that the torch is displaced by the actuator(s) entirely in said plane substantially transverse to the advancement direction, i.e. the displacement of the torch by the actuator(s) does not cause displacement of the torch outside said plane.

“A plane substantially transverse to the advancement direction of the base relative to the parts” is understood to mean a plane of which the normal forms an angle less than 20°, better less than 10°, better still less than 5° with the advancement direction of the base relative to the parts, an angle of 0° forming a perfectly transverse plane.

### ACTUATORS

The holder for the torch can be connected to the first and/or second actuator(s) by an offsetting arm.

The first actuator may be a linear or rotary actuator.

The second actuator may be a linear or rotary actuator.

The linear actuator(s) make it possible to translationally displace the holder for the torch.

In one embodiment, the first actuator is a linear actuator and the second actuator is a rotary actuator and makes it possible to rotate the torch, preferably about an axis substantially parallel to the advancement direction.

In another embodiment, the first and the second actuator are linear actuators, the displacement directions of the linear actuators preferably being mutually orthogonal. In this case, the holder for the torch can be connected to the first and/or second actuator(s) by an offsetting arm.

In another embodiment, the first actuator is a linear actuator, and the second actuator is a rotary actuator and makes it possible to rotate the torch, preferably about an axis substantially parallel to the advancement direction, and wherein the system comprises a linear third actuator which makes it possible to translationally displace the torch, the displacement directions of the linear actuators preferably being mutually orthogonal.

The use of a rotary actuator makes it possible to adapt the orientation of the torch during the welding operation, in particular to keep an orientation of the welding torch as close as possible to the normal to the surface on which the weld is produced.

An “axis substantially parallel to the advancement direction” is understood to be an axis forming an angle less than 20°, better less than 10°, better still less than 5° with the advancement direction at a given time.

If required, the rotary actuator is positioned at the holder for the torch, in particular at an end of the offsetting arm.

The control unit is preferably configured to control the first, second and third actuators in coordinated fashion on the basis of the trajectory to be imparted to the end of the wire electrode. Such coordinated control allows a great freedom of movement of the torch, and this promotes an optimum orientation of the welding torch.

The first, the second and, as the case may be, the third actuator may each have a motor and a position sensor.

One of the actuators may displace a first intermediate holder in a direction Y generally parallel to the plane of the base. The other actuator may be supported by the first intermediate holder and displace a second intermediate holder in a direction Z perpendicular to the direction Y. The third actuator may be supported by the second intermediate holder and rotate the aforementioned holder for the torch about an axis X perpendicular to the axes Z and Y.

### BASE

The base may be a movable carriage, a portal frame or a rotary column.

The base, in particular the carriage, may have wheels, in particular each with an axis of rotation perpendicular to the advancement direction, and/or tracks, in particular motor-driven tracks, for displacing the base along the parts to be welded. The carriage may be displaced by rolling it on the parts to be welded, or on at least one guide rail, or even on a rack. The carriage can be guided, where appropriate, by bearing against one of the parts to be welded, in particular if that part is a stiffener.

The base, in particular the carriage, may have four motor-driven wheels, each wheel being able to be controlled independently from the others in order to orient the base in the desired direction.

The base, in particular the carriage, may have at least one wheelset, or even two wheelsets, in particular a right-hand wheelset and a left-hand wheelset, which are motor-driven independently.

The use of wheels allows rail-less guidance and therefore limits the logistics needed for installation.

The base may have a grip element allowing the operator to grasp and transport the base, for example in just one hand.

The base may have an electrical power supply system, in particular a battery. The use of a battery makes it possible to avoid using a bulky and external electric cable.

The base may have one or more magnets for holding it by magnetic attraction on one of the parts to be joined.

### CONTROL AND GUIDANCE

The control unit may be programmed to produce a weld autonomously and/or semi-autonomously.

“Autonomously” is to be understood as meaning that the system is capable of producing the weld without operator intervention.

“Semi-autonomously” is understood as meaning that the system is capable of producing the weld under operator supervision, and the operator can give orders to the system in order to correct certain parameters for the displacement of the base or of the weld.

The control unit may have any processor, for example a microcontroller and interfaces for interacting with the environment thereof, for example sensor(s), power stage for controlling the motors, HMI, transceiver for exchanging data with a wireless remote control.

The control unit may, if required, be removably mounted on the system, in particular on the base. In this case, the system may have a receiving region with a series of connectors for mounting the control unit on the base.

The system may comprise a remote control, notably a wireless remote control, preferably a telecontrol, allowing an operator to remotely control the displacement of the base relative to the parts to be welded, in particular the advancement rate of the base, the displacement direction of the base, and/or welding parameters.

The remote control may also be configured to make it possible to provide details about the geometry of the weld to be produced.

The control unit may be configured to receive, via a user interface or the remote control, data about the geometry of the weld to be produced, and the data may include the angle between the two parts, the opening angle of a bevel between the parts, the material of the parts and/or the thickness of the parts. The control unit may be designed to take these received data as a basis to automatically determine one or more operating parameters of the base and of the actuators.

The system may comprise a transceiver which communicates with the telecontrol and is either contained in the control unit or independent.

The system may comprise a guide means, in particular including at least one guide rail. This guide rail may be fastened magnetically or otherwise to one of the parts.

The system may comprise a guide laser which forms a visual frame of reference on the parts to be welded, in particular is positioned on the edge of the bevel of the weld joint, for guiding the base.

The system may comprise a geometry sensor for the parts, in particular a profilometer, preferably a laser profilometer, which measures the profile of the parts to be welded upstream of the welding torch in the displacement direction thereof. The actuators can be controlled automatically on the basis of the profile thus measured.

The system may comprise a guide camera. It is possible for the guidance to be performed, or not performed, using a reference wire placed on the parts.

If required, the control unit is configured to control the first, second and third actuators in coordinated fashion on the basis of the trajectory to be imparted to an end of the wire electrode.

### WELDING TORCH

The system may comprise a welding torch received by the holder for the torch.

The welding torch may be removably mounted on the holder for the torch.

The torch may be configured to unspool the wire electrode during the welding operation.

The welding torch may be a standard torch that can be used for MAG or MIG welding.

The system may comprise one welding torch or two, or even more than two, welding torches. In this case, for each torch, the system may comprise a holder for the torch, a first actuator, a second actuator and, optionally, a third actuator. Each of the torches may be offset from the other(s) in the advancement direction.

### WELDING STATION

The system may comprise a welding station, in particular a standard welding station that can be used for an open arc welding operation. A “standard welding station” denotes a welding station commonly used for open arc welding operations, for example of the MAG or MIG type. The use of a standard welding station makes it possible to significantly reduce the cost of the system, since this type of station is commonly commercially available.

The welding station, also referred to as generator, may be fixed in place relative to the parts to be welded during the displacement of the base.

In a variant, the station may be displaced during the welding operation relative to the parts, in particular to specific points as the welding progresses. For example, the welding station is placed at a first location and the base is displaced over a certain distance without moving the welding station, the hose connecting the welding torch to the welding station being deployed during this operation. Then, the welding station can be brought to a second location which moves it closer to the base, and the welding operation continues.

In another variant, the station may itself be equipped with wheels and be continuously displaced during the welding operation, for example driven along via the base, or supported by transport means which are autonomous or slaved to the displacement of the base.

The welding station may have a spool of filler metal for the wire electrode. The weld material may be fed from the welding station to the welding torch through a guide present within the aforementioned hose, for example.

The arc welding station may be an MIG (“Metal Inert Gas”) and/or MAG (“Metal Active Gas”) welding station, for which the flow of shielding gas is activated, a TIG (“Tungsten Inert Gas”) welding station, a submerged arc welding station, an electroslag welding station, a plasma arc welding station, or any other type of arc welding station.

The welding station may have a ground clip configured to be positioned on at least one of the parts to be welded.

The welding station may have a control panel for controlling welding parameters, in particular the electrical voltage, the electrical current, the arc mode and/or the filler metal unspooling rate.

### WELDING METHOD

The invention also relates, according to another of its aspects, to a method for welding two parts to one another using a system as defined above, wherein the base is set in continuous or intermittent motion relative to the parts to be welded,
and, when the base is moving and/or between two movements thereof:
the welding torch generates an arc,
the welding torch is displaced by coordinated movements of said first and second actuators such that a weld bead is formed.

The method according to the invention makes it possible to produce welds on different geometries with one and the same system via the coordinated movements of the first and second actuators.

Specifically, the coordinated movements of the first and second actuators allow precise positioning of the welding torch at any point in a plane substantially transverse to the advancement direction adjacent to the welding area, thus making it possible to optimize the trajectory of the weld.

The movements of the first and second actuators can be coordinated with the displacement of the base. In particular, they can vary on the basis of the advancement rate. For example, when the base slows down, the displacement speed of the first and second actuators can also be slowed down.

When the first actuator is a linear actuator and the second actuator is a rotary actuator, the welding torch may be displaced by linear movements of the first actuator coordinated with rotary movements of the second actuator, making it possible to rotate the torch relative to the parts, in particular about an axis substantially parallel to the advancement direction.

The welding torch may be displaced by coordinated movements of the first and second actuators and of a third actuator, one of the three actuators preferably being a rotary actuator, the two other actuators being linear actuators.

The movements of the third actuator can also be coordinated with the displacement of the base.

The welding torch can be swept in a direction orthogonal to the advancement direction.

The sweeping can be carried out at a constant spatial frequency, in particular when the weld bead to be produced has a substantially constant geometry. In a variant, it may be varied, in particular when the weld bead to be produced has a highly variable geometry.

The weld bead produced may have a straight portion.

The weld bead produced may have a curved portion. The radius of curvature of the curved portion may be constant or non-constant.

With preference, when the system comprises a rotary actuator, the position of that actuator varies during the formation of a curved portion.

For example, the weld bead may have two curved portions between which a straight portion extends.

A curved portion of the weld bead may be produced after a straight portion of the weld bead. The displacement direction of the linear actuator(s) relative to the parts during the formation of the curved portion are preferably reversed in relation to those during the formation of the immediately preceding straight portion.

With preference, when the system comprises a linear actuator and a rotary actuator, the position of the rotary actuator, in particular of the center of rotation thereof with respect to the aforementioned second intermediate holder, varies during the formation of a curved portion, owing to the actuation of the linear actuator(s).

Coordinated movements of the first actuator, the second actuator and, as the case may be, the third actuator may cause the welding torch to rotate relative to the parts about an axis substantially parallel to the advancement direction and passing through an end of the wire electrode, in particular without a translational movement of this end relative to the parts.

During the formation of the weld bead, the wire electrode may form an angle less than 70°, preferably less than 45° in relation to the normal to the surface, in particular the bevel, to be welded that faces an end of the wire electrode.

A weld bead can be produced between the parts which has a cross section with a straight portion and/or a curved portion, in particular two curved portions at each of the ends of the straight portion.

It is possible to produce a weld bead which is straight, triangular, V-shaped, in a fir-tree pattern, curved, or of any desired shape.

The control unit preferably coordinates the movements of the first actuator, the second actuator and, as the case may be, the third actuator such that the displacement of the end of the wire electrode is slaved to a predetermined trajectory of the wire electrode.

To slave the displacement of the end of the wire electrode, the control unit may change the frame of reference formed by the axes of the actuators toward an end of the wire electrode.

The change of the frame of reference may constitute a change of the orthonormal frame of reference formed by the axes of displacement of the first and the second actuator, when the latter are linear actuators, toward an orthonormal frame of reference centered on the end of the wire electrode, one of the axes of this frame of reference coinciding with the longitudinal axis of the wire electrode.

The change is preferably performed such that the axes of the frames of reference before and after the transfer are comprised in one and the same plane, which is preferably substantially transverse to the advancement direction.

For example, when the first and second actuators are linear actuators, to displace the wire electrode by a distance Δ in a movement direction orthogonal to the longitudinal axis of the wire electrode and to the advancement direction, and if α is the smallest angle between the movement direction of the wire electrode and the axis of displacement of the second actuator, the first actuator will be displaced by a distance equal to the product of Δ and the sine of α and the second actuator will be displaced by a distance equal to the product of Δ and the cosine of α.

For example, when the first actuator is a linear actuator and the second actuator is a rotary actuator, if L is the distance between the end of the wire electrode and the second actuator, the displacement distance Δ of the end of the wire electrode along the axis of the first linear actuator is equal to the sum of the displacement of the first actuator, the product 2L, and the cosine of the rotational half-angle of the second actuator. Thus, for a zero displacement of the end of the wire electrode along the axis of the first actuator and for a given angular amplitude for the wire electrode, which is therefore equal to the amplitude of rotation of the second actuator, it is possible to deduce the amplitude of displacement of the first actuator therefrom. Similarly, for a weld with a given orientation of the wire electrode, i.e. a fixed angular position for the second actuator, and for an amplitude Δ of displacement of the end of the wire electrode, it is possible to deduce the amplitude of movement of the first actuator therefrom.

For example, for a linear first actuator and a linear second actuator and a rotary third actuator, to make the welding torch rotate about the end of the wire electrode by an angle β, if α is the smallest angle between the axis of displacement of the second actuator and an axis orthogonal to the longitudinal axis of the wire electrode in a plane transverse to the advancement direction before rotation and if L is the distance between the end of the wire electrode and the third actuator, the first actuator will be displaced by L(sin(α+β)−sin(α)), the second actuator will be displaced by L(cos(α)−cos(α+β)) and the third actuator will rotate through an angle β.

With preference, the axis of displacement of one of the actuators, in particular the first actuator, is parallel to one of the parts during the welding operation.

### PART TO BE WELDED

The two parts may form different angles with one another, in particular an angle of approximately 90° or approximately 180°.

The parts may have a bevel between them which forms an opening between them with an angle less than or equal to 100°, in particular an angle less than or equal to 60°, for example less than or equal to 40°.

The parts may have a bevel between them that has a projection in the lower portion.

The parts may be metallic, in particular comprise stainless or non-stainless steel, aluminum or one of its alloys.

The parts may be metal sheets.

### BRIEF DESCRIPTION OF THE DRAWINGS

The invention may be understood better from reading the following detailed description of nonlimiting implementation examples thereof, and from examining the appended drawing, in which:

FIG. 1 schematically illustrates a front view of an example of a system according to the invention, positioned on parts to be welded laid flat,

FIG. 2 is a view similar to FIG. 1, illustrating the system in the course of a welding method according to the invention,

FIG. 3 illustrates the progression of the welding method in FIG. 2,

FIG. 4 schematically illustrates a front view of another example of a system according to the invention, positioned on parts to be welded that form a right angle between them,

FIG. 5 is an enlargement of FIG. 4 according to V,

FIG. 6 is a view similar to FIG. 5, illustrating the formation of a straight portion of a weld bead,

FIG. 7 is a view similar to FIG. 5, illustrating the formation of a curved portion of a weld bead, and

FIG. 8 schematically illustrates a top view of the system in FIG. 7.

### DETAILED DESCRIPTION

In the rest of the description, elements that are identical or have identical functions bear the same reference signs. For the sake of conciseness of the present description, they are not described for each of the figures, only the differences between the embodiments being described.

The figures have not always been drawn to scale, for the sake of clarity.

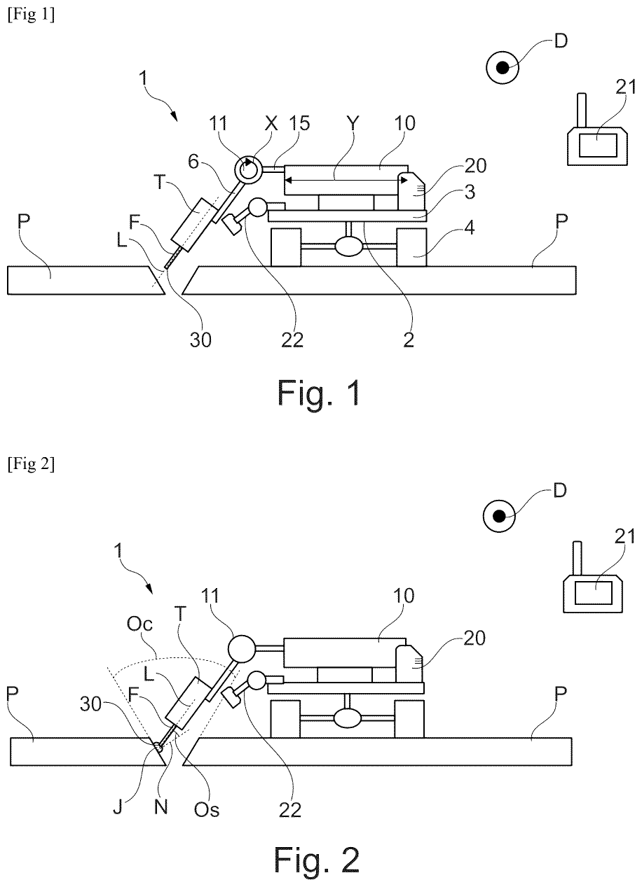

FIG. 1 illustrates an example of a system 1 for welding two parts P to one another.

The system comprises a base, in this example a carriage 2, arranged for displacement on the surface of one of the parts P in an advancement direction D.

In this example, the carriage 2 has a platform 3 mounted on wheels 4, in this example four wheels, with only two of them being visible in FIG. 1.

Each wheel 4 is a drive wheel.

The system 1 comprises a holder 6 for an arc welding torch T with a wire electrode F.

The welding torch T is for example a standard torch used for MIG or MAG welding, a TIG welding station, a submerged arc welding station, an electroslag welding station, a plasma arc welding station, or any other type of arc welding station.

In this example, the torch T is connected to a standard welding station, which is not shown for the sake of clarity of the drawings.

The system 1 also comprises, mounted on the platform 3, a linear first actuator 10 connected via an offsetting arm 15 to a rotary second actuator 11, which is itself connected to the holder 6 for the torch T.

The first actuator 10 makes it possible to translationally displace the arm 15, and thus the second actuator 11, the holder 6 and the torch T, relative to the carriage 2 in a direction Y orthogonal to the normal of the surface of the base 3.

The axis Y is not parallel to the longitudinal axis L of the torch T.

The second actuator 11 has an axis X of rotation parallel to the advancement direction D.

The two actuators 10 and 11 operate with motors and position sensors.

The system 1 also comprises a control unit 20 configured to control the first actuator 10 and the second actuator 11 in coordinated fashion on the basis of the trajectory to be imparted to the end 30 of the wire electrode F.

The control unit 20 makes it possible to produce the weld autonomously or semi-autonomously.

In this example, the control unit 20 is removably mounted on the platform 3 on a receiving region.

The control unit 20 also has a rechargeable battery for supplying it and the actuators 10 and 11 with electrical power.

The system 1 comprises a wireless remote control 21 communicating with the control unit 20 via a transceiver system or via a wired connection when it is placed on top.

The remote control 21 forms a user interface allowing an operator to control and possibly correct the displacement of the carriage 2 remotely.

The remote control 21 also makes it possible to enter data about the geometry of the weld to be produced, such as the angle between the parts P, the thickness of the parts P or the angle of a bevel between the parts P.

In this example, the system 1 comprises a laser profilometer 22 which measures the profile of the parts P upstream of the welding torch T in the advancement direction D thereof.

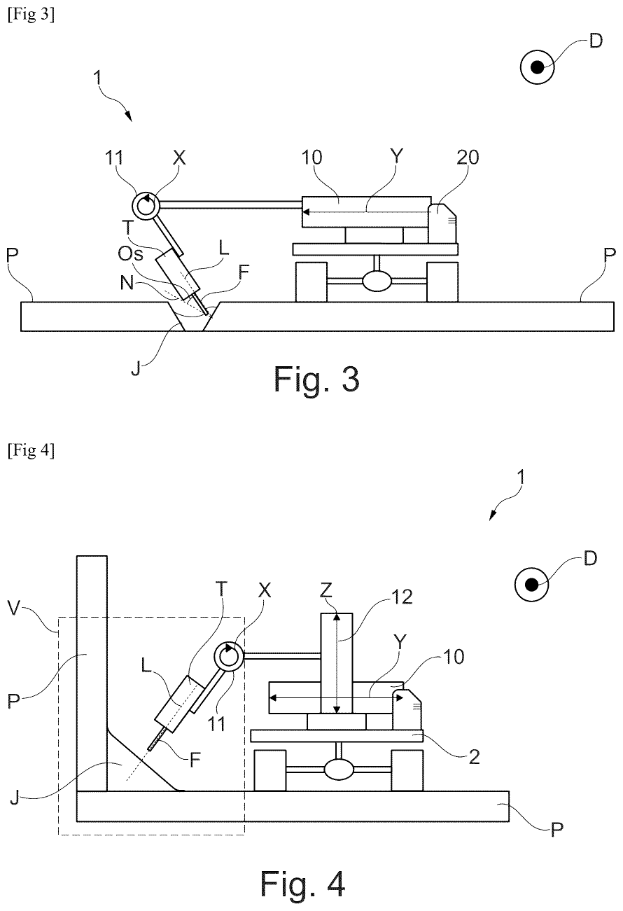

FIGS. 2 and 3 illustrate a first example of a welding method using a system 1 as described above.

In this first example, the parts P are both laid flat. They each have a bevel forming an opening of angle Oc of 40° between them.

In a first step, the system 1 is positioned on the outer surface of one of the parts P. Then, for example using the remote control 21, a user transmits information about the geometry of the parts P to the control unit 20.

The torch T is then displaced to position it for the welding operation.

The carriage 2 is then set in motion in the direction D and, at the same time, the wire electrode F generates an arc with one of the parts and is unspooled by the torch T, to form the weld bead J. In this example, the base 2 is displaced continuously or intermittently.

The first actuator 10 and the second actuator 11 use coordinated movements controlled by the control unit 20 to displace the torch T to form the weld bead J.

As illustrated in FIG. 2, the two actuators 10 and 11 are displaced such that the longitudinal axis L of the wire electrode F is kept close to the normal N to the surface facing the end 30 of the wire electrode F. In this example, the longitudinal axis L of the torch T forms an angle Os less than 15° with the normal N.

To produce the weld bead J, the torch T is displaced such that it carries out a sweep orthogonal to the direction D. During this sweep, coordinated movements of the two actuators 10 and 11 are used to modify the orientation of the torch T such that the longitudinal axis L of the wire electrode F is kept as close as possible to the normal N to the surface on which the weld bead J is formed.

In this regard, FIG. 3 illustrates the position of the welding torch T after a first sweep from left to right. In this position, and during the sweep, the angle Os remains less than 15°.

This orientation is maintained by the coordinated movements of the two actuators 10 and 11.

For example, when the torch T is being moved from the left-hand position in FIG. 2 to the right-hand position in FIG. 3, the first actuator 10 is displaced from left to right along the axis Y and the second actuator 11 rotates counterclockwise relative to the direction D about the axis X. In a variant, it is possible for the first actuator 10 to be fixed in place.

Such an orientation of the wire electrode F during the sweep allows a good impact of the wire electrode F, good penetration of the weld and therefore a good attachment thereof. This makes it possible to obtain a weld bead J with a good geometry and no or very few defects.

During the displacement of the carriage 2, the sweep is performed for example from right to left and then from left to right, until the welding is finished. In this example, the sweep movements, and therefore the movements of the two actuators 10 and 11, are coordinated with the displacement of the carriage 2 such that a sweep of relatively constant frequency is obtained. The unspooling rate of the wire electrode F can be coordinated with the sweep speed and/or the displacement speed of the carriage 2.

FIGS. 4 to 7 illustrate a variant of the system and the method in which the two parts P form a right angle between them and where the system comprises three actuators 10, 11 and 12.

In this example, the first actuator 10 and the second actuator 11 are identical to the preceding example. The first actuator 10 also makes it possible to translationally displace the third actuator 12.

In this example, the third actuator 12 makes it possible to translationally displace the arm 15, and thus the second actuator 11, the holder 6 and the torch T, relative to the carriage 2 in a direction Z normal to the surface of the platform 3 and transverse to the advancement direction D.

In this example, the weld bead J to be produced has a substantially triangular cross section in a plane transverse to the advancement direction D.

As illustrated, the axis Y of displacement of the first actuator 10 and the axis Z of displacement of the third actuator 12 are mutually orthogonal, are comprised in a plane transverse to the advancement direction D and are not parallel to the longitudinal axis L of the wire F of the torch T.

The axis X of rotation of the second actuator 11 is, as before, parallel to the advancement direction D.

In this example, the base 2 is set in intermittent motion.

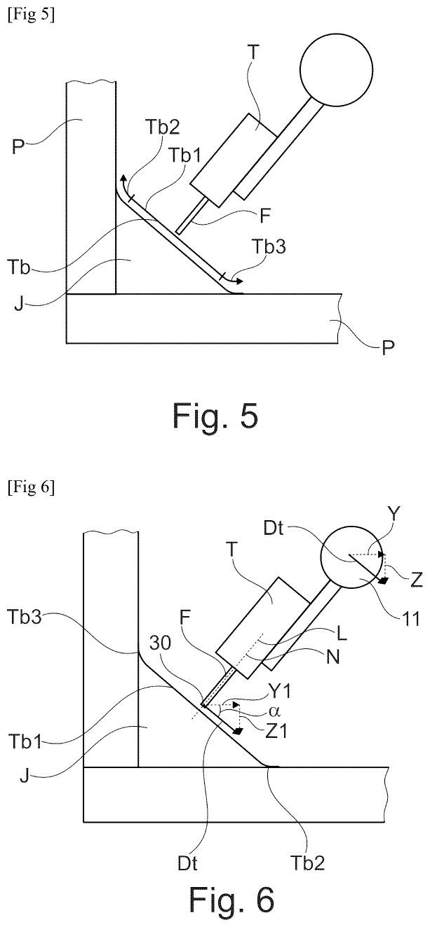

The sweep trajectory Tb traveled by the end 30 of the wire electrode F in the course of the welding operation is illustrated in the partial enlargement of FIG. 4 given in FIG. 5.

This trajectory Tb has a straight portion Tb1 and two curved portions Tb2 and Tb3.

The sweep is carried out periodically, for example by firstly producing the curved portion Tb2, then the straight portion Tb1, then the curved portion Tb3, then the straight portion Tb1 again and so on. This sweep is preferably carried out when the carriage 2 is being displaced.

It is also possible to dip the wire electrode F into the middle of the straight portion Tb1, forming a “fir-tree-pattern” weld.

To produce the straight portion Tb1, as illustrated in FIG. 6, the linear actuators 10 and 12 are actuated while the orientation of the rotary actuator 11 stays the same.

The displacement of the third actuator 12 along the axis Z causes a displacement Z1 of the end 30 of the torch T. In this example, the displacement of the third actuator 12 along Z is equal to the product of the norm of Dt and the sine of the smallest angle a between Dt and the axis Z.

The angle α also corresponds to the smallest angle between the axis Z and an axis orthogonal to the longitudinal axis L of the wire electrode F in a plane transverse to the advancement direction D.

The displacement of the actuator 10 along the axis Y causes a displacement Y1 of the end 30 of the torch T. In this example, the displacement of the first actuator 10 along Y is equal to the product of the norm of Dt and the cosine of the angle α.

The sum of the displacements along the axes Z1 and Y1 causes a displacement Dt of the end 30 of the torch T, in a plane transverse to the advancement direction D.

The second actuator 11, during the formation of the straight portion, is also displaced along the direction Dt.

As illustrated, during the formation of the straight portion Tb1, the longitudinal axis L of the wire electrode F coincides with the normal to the surface N on which the weld is produced, in the present case on an already formed portion of the weld bead J.

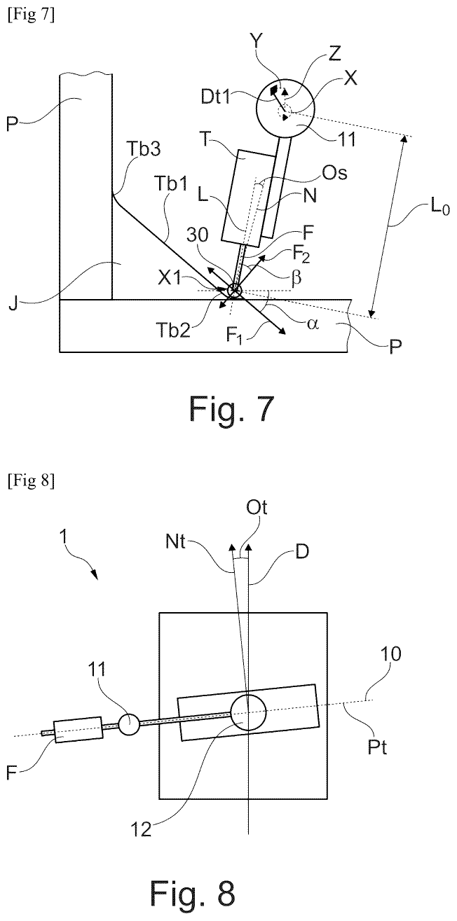

The formation of the curved portion Tb2 which follows the formation of the straight portion Tb1 in FIG. 6 is illustrated in FIG. 7.

To create the curved portion Tb2, the weld is produced by rotating the wire electrode F about an axis X1 parallel to the advancement direction D and passing through the end 30 of the wire electrode F, this axis X1 being positioned in the center of curvature of the curved portion Tb2.

Thus, to form the curved portion Tb2, the end 30 may be solely rotationally displaced. There is not, for example, any translational movement of the end 30. In a variant, there may be a slight translational movement there.

This rotation about the end 30 requires linear movements of the first actuator 10 and the third actuator 12 along the axes Z and Y in opposite directions to those during the formation of the straight portion Tb1.

During the formation of the curved portion Tb2, the second actuator 11 is rotated about the axis X in the same direction of rotation as that of the end 30 about the axis X1.

In FIG. 7, the axis F₁ is an axis orthogonal to the longitudinal axis L of the wire electrode F in a plane transverse to the advancement direction D before rotation and the axis F₂ illustrates the longitudinal axis L of the wire electrode F before rotation.

As illustrated, to form the curved portion, the wire electrode F rotates by an angle β with respect to the axis F₂.

To perform this rotation, the third actuator 12 has been displaced along the axis Z by L₀(sin(α+β)−sin(α)), the first actuator 10 along the axis Y by L₀(cos(α)−cos(α+β)) and the second actuator has rotated about X by an angle β, where L₀ is the length between the end 30 and the second actuator 11.

The different movements of the linear actuators 10 and 12 also cause a linear displacement of the second actuator 11 relative to the parts P in a direction Dt1.

This particular movement of the torch T about the end 30 makes it possible to keep the longitudinal axis L of the wire electrode F as close as possible to the normal N to the surface facing the end 30.

For example, in this case the angle Os is less than 10°.

A similar process is used to produce the curved portion Tb3, the different displacement or rotational directions being reversed in relation to those during the formation of the curved portion Tb2.

These movements of the three actuators 10, 11 and 12 are coordinated by the control unit 20 during the formation of the various portions.

In particular, the control unit 20 coordinates the movements such that the displacement of the end 30 of the wire electrode F is slaved to a predetermined trajectory thereof.

In a variant illustrated in FIG. 8, the actuators 10, 11 and 12 can allow the displacement of the torch T in a plane Pt, the normal Nt to which forms an angle Ot, referred to as thrust angle, of 5° with respect to the advancement direction D.

In a variant which is not illustrated, the angle Ot could be inverted, i.e. the torch T points slightly in the advancement direction D.

The invention which has just been described is not limited to the examples that have just been described.

In particular, the angle between the parts P may be open or closed differently, for example ranging between 0°and 360°.

The cross section of the weld bead J may have a number, for example between 1 and 4, of differently curved portions.

The weld bead J may have a number, for example between 1 and 4, of differently straight portions.

The movements of the three actuators 10, 11 and 12 may be coordinated such that a curved portion is formed by a rotation of the torch T about the end 30 and a translational movement of this end.

The movements of the actuators 10, 11 and 12 may be generated in a plane the normal to which forms an angle less than 20° with the advancement direction.

1. An arc welding system for welding two parts to one another, comprising:
a base which is movable relative to the surface of one of the parts to be welded in an advancement direction,
a holder for a torch, the holder being arranged to receive an arc welding torch with a wire electrode,
a first actuator and a second actuator for displacing the holder relative to the base in a plane substantially transverse to the advancement direction of the base relative to the parts and in two different directions neither of which is parallel to the longitudinal axis of the torch, and
a control unit configured to control the first and second actuators in coordinated fashion on the basis of the trajectory to be imparted to an end of the wire electrode.

2. The system as claimed in claim 1, wherein the first actuator is a linear actuator and the second actuator is a rotary actuator and makes it possible to rotate the torch.

3. The system as claimed in claim 1, wherein the first and the second actuator are linear actuators, the displacement directions of the linear actuators.

4. The system as claimed in claim 1, wherein the first actuator is a linear actuator, and the second actuator is a rotary actuator and makes it possible to rotate the torch, and wherein the system comprises a linear third actuator which makes it possible to translationally displace the torch, the displacement directions of the linear actuators.

5. The system as claimed in claim 1, wherein the base is a movable carriage, a portal frame or a rotary column.

6. The system as claimed in claim 1, wherein the base has wheels each with an axis of rotation perpendicular to the advancement direction, and/or motor-driven tracks for displacing the base along the parts to be welded.

7. The system as claimed in claim 1, comprising at least one geometry sensor for the parts which measures the profile of the parts to be welded upstream of the welding torch in the displacement direction thereof, and the actuators can be controlled automatically on the basis of the profile thus measured.

8. The system [(1)] as claimed in a claim 1, comprising a welding torch received by the holder for the torch.

9. A method for welding two parts to one another using a system as claimed in claim 1, wherein the base is set in continuous or intermittent motion relative to the parts to be welded,
and, when the base is moving and/or between two movements thereof:
the welding torch generates an arc,
the welding torch is displaced by coordinated movements of said first and second actuators such that a weld bead is formed.

10. The method as claimed in claim 9, wherein the movements of the first and second actuators are coordinated with the displacement of the base.

11. The method as claimed in claim 9, wherein the first actuator is a linear actuator, the second actuator being a rotary actuator, the welding torch being displaced by linear movements of the first actuator coordinated with rotary movements of the second actuator, making it possible to rotate the torch relative to the parts, in particular about an axis substantially parallel to the advancement direction.

12. The method as claimed in claim 9, wherein the welding torch is displaced by coordinated movements of the first and second actuators and of a third actuator, one of the three actuators being a rotary actuator, the two other actuators being linear actuators.

13. The method as claimed in claim 9, wherein the welding torch is swept in a direction orthogonal to the advancement direction.

14. The method as claimed in claim 9, wherein the weld bead produced has a straight portion and/or a curved portion.

15. The method as claimed in claim 9, wherein a curved portion of the weld bead is produced after a straight portion of the weld bead, the displacement directions of the linear actuator(s) relative to the parts during the formation of the curved portion being reversed in relation to those during the formation of the immediately preceding straight portion.

16. The method as claimed in claim 9, wherein coordinated movements of the first actuator, the second actuator and, as the case may be, the third actuator cause the welding torch to rotate relative to the parts about an axis substantially parallel to the advancement direction and passing through an end of the wire electrode.

17. The method as claimed in claim 9, wherein, during the formation of the weld bead, the wire electrode forms an angle less than 70° in relation to the normal to the surface to be welded that faces an end of the wire electrode.

18. The method as claimed in claim 9, wherein a weld bead is produced between the parts which has a cross section with a straight portion and a curved portion (Tb2, Tb3), in particular two curved portions (Tb2, Tb3) at each of the ends of the straight portion (Tb1).

19. The method as claimed in claim 9, wherein the control unit coordinates the movements of the first actuator, the second actuator and, as the case may be, the third actuator such that the displacement of the end of the wire electrode is slaved to a predetermined trajectory of the wire electrode.
